(19) United States
(12) Patent Application Publication
(10) Pub. No.: US 2019/0337392 A1
(43) Pub. Date: Nov. 7, 2019

(54) Storing and Providing Electric Energy to Equipment

(71) Applicants: Mahendra Ladharam Joshi, Houston, TX (US); Dewey Parkey, JR., Houston, TX (US); Richard Luht, Houston, TX (US)

(72) Inventors: Mahendra Ladharam Joshi, Houston, TX (US); Dewey Parkey, JR., Houston, TX (US); Richard Luht, Houston, TX (US)

(73) Assignee: Baker Hughes, a GE company, LLC, Houston, TX (US)

(21) Appl. No.: 15/969,509

(22) Filed: May 2, 2018

(51) Int. Cl. B60L 11/18; H02J 7/00

(52) U.S. Cl. CPC B60L 11/1824; H01M 2010/4271; H02J 7/0021

(57) ABSTRACT

Examples of techniques for storing and providing electric energy to equipment at the sites are disclosed. In one example implementation according to aspects of the present disclosure, a method includes receiving, at a charging hub, electric energy from a power source. The method further includes charging, at the charging hub, an electric energy storage device associated with an electric powered vehicle by providing the electric energy from the power source to the electric energy storage device. The method further includes relocating the electric powered vehicle from the charging hub to a site. The method further includes providing electric energy from the electric energy storage device to the electric powered vehicle and an electric component at the site to cause the electric component to operate.

### BACKGROUND

Embodiments of the present invention relate generally to electric power and, more particularly, to storing and providing electric energy to equipment at sites.

Operations at sites may utilize equipment to perform various functions. For example, hydrocarbon exploration and energy industries employ systems (having equipment) and operations to accomplish activities including drilling, formation evaluation, stimulation, wellbore intervention and production. Hydrocarbon production can be improved, especially in more challenging types of formations (e.g., shale formations, tight reservoirs), by using stimulation techniques. One such technique is hydraulic fracturing, in which stimulation fluid is pumped into a formation to generate or open fractures and release stored hydrocarbons. The equipment used to perform stimulation techniques is often powered by diesel semi-trucks with engines.

### SUMMARY

Embodiments of the present invention are directed to method that includes receiving, at a charging hub, electric energy from a power source. The method further includes charging, at the charging hub, an electric energy storage device associated with an electric powered vehicle by providing the electric energy from the power source to the electric energy storage device. The method further includes relocating the electric powered vehicle from the charging hub to a site. The method further includes providing electric energy from the electric energy storage device to the electric powered vehicle and an electric component at the site to cause the electric component to operate.

Embodiments of the present invention are also directed to a mobile hydraulic fracturing unit that includes a prime mover. The mobile hydraulic fracturing unit further includes at least one of a sand loader assembly, pump assembly and a blender assembly. The mobile hydraulic fracturing unit further includes an electric motor coupled to the at least one of the pump assembly and the blender assembly. The mobile hydraulic fracturing unit further includes an electric energy storage device to provide electric energy to the prime mover and the electric motor coupled to the at least one of the pump assembly and the blender assembly.

Embodiments of the present invention are also directed to a hydraulic fracturing operation that includes a hydraulic fracturing unit comprising a hydraulic fracturing component and an electric motor coupled to the hydraulic fracturing component. The hydraulic fracturing operation also includes a mobile unit comprising an electric energy storage device to provide electric energy to the electric motor of the hydraulic fracturing unit.

### BRIEF DESCRIPTION OF THE DRAWINGS

The following descriptions should not be considered limiting in any way. With reference to the accompanying drawings, like elements are numbered alike:

FIG. 1 depicts an environment for providing electric energy to sites using mobile units configured with onboard electric energy storage devices that can be used to store and provide electric energy to equipment at the sites according to one or more embodiments of the present invention;

FIG. 2A depicts a wellbore operation at which electric energy is supplied by a fleet of mobile units according to one or more embodiments of the present invention;

FIG. 2B depicts a wellbore operation at which electric energy is supplied by a fleet of mobile units according to one or more embodiments of the present invention;

FIG. 3 depicts an arrangement of electric energy storage devices according to one or more embodiments of the present invention;

FIG. 4 depicts a map indicating the position of mobile units, charging hubs, power sources, and sites according to one or more embodiments of the present invention;

FIG. 5 depicts a method for providing storing and providing electric energy to equipment at the sites according to one or more embodiments of the present invention; and

FIG. 6 depicts a block diagram of a processing system for implementing the techniques described herein according to aspects of the present disclosure.

### DETAILED DESCRIPTION

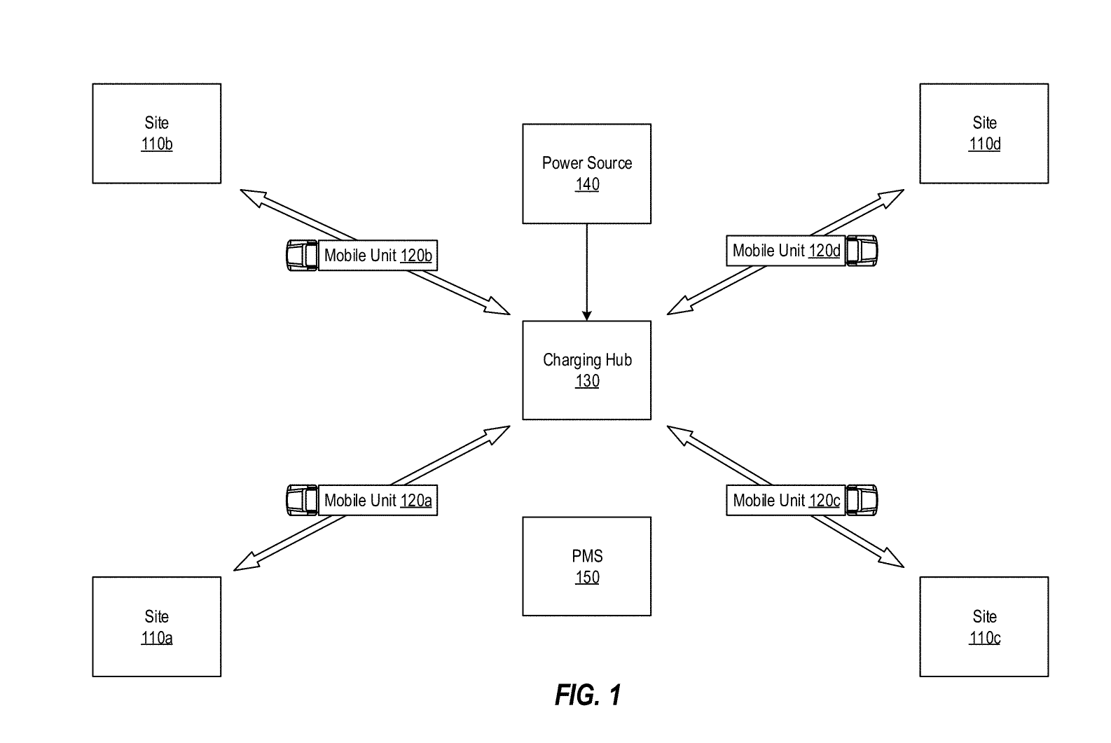

A detailed description of one or more embodiments of the disclosed apparatus, system, and/or method are presented herein by way of exemplification and not limitation with reference to the figures. FIG. 1 depicts an environment for providing electric energy to sites using mobile units configured with onboard electric energy storage devices that can be used to store and provide electric energy to equipment at the sites.

The sites 110a, 110b, 110c, 110d (collectively “sites 110”) and can be various types of sites, such as well pads, oil, and gas operations sites, construction sites, emergency sites, or other sites. The sites 110 often include equipment that utilizes electric energy to operate. For example, at a wellbore operation, equipment such as pumps (e.g., high-pressure pumps), blenders, drilling or workover rigs, coil tubing units, wireline units, cementing systems, control systems, sand loaders etc. utilize electric energy to function. Other sites 100 can also use electric energy to operate equipment. For emergency sites, electric energy may be needed to operate equipment that is otherwise powered by grid power, which may be unavailable due to the emergency (e.g., a natural disaster). Other types of sites 110 can include field pumping oil/water sites, gas compression sites, artificial lift using electrical submersible pump sites, gas lift compressor sites, rod lift or plunger pump sites, jet pump sites, powering downhole tools at wellbore sites, and the like.

The mobile units 120a, 120b, 120c, 120d (collectively “mobile units 120”) transport electric energy to the sites 110 by storing electric energy in electric energy storage devices (e.g., rechargeable batteries, capacitors, etc.) onboard the mobile units 120. An electric energy storage unit can include, for example, a rechargeable battery or a bank of rechargeable batteries. As used herein, “mobile units” refers to any suitable unit that can be relocated and is configurable to transport portable electric energy storage devices such as batteries. Examples of mobile units as used herein include, but are not limited to, semi-trailer trucks, flatbed trucks, vans, box trucks, rail cars, buses, and other suitable mobile units that can move from one location to another and can transport electric energy storage devices. It should be appreciated that, in one or more embodiments of the present invention, a mobile unit (e.g., the mobile unit 120a, the mobile unit 120b, etc.) can include a trailer upon, on, or in which the electric energy storage device(s) are located. The mobile unit can be moved by a prime mover, such as a truck, that is configured to connect to the mobile unit. In such cases, a single prime mover can relocate one or more of the mobile units 120 and the mobile units 120 can be relocated by different prime movers. The prime movers can be powered by gasoline, diesel, biodiesel, propane, electric energy, or another suitable fuel source. In the case of electric powered prime movers (or electric powered mobile units 120) (also referred to as “electric powered vehicles”), the electric energy storage device of the mobile unit 120 can be used to power the mobile unit 120 (and/or a prime mover connected thereto). It should further be appreciated that, in one or more embodiments of the present invention, one or more of the mobile units 120 can be operated autonomously.

The mobile units 120 receive electric energy, which is stored in the electric energy storage devices, at a charging hub 130. The charging hub 130 receives electric energy from a power source 140. The power source 140 can be an electric utility supplying grid power, a stationary or trailer mounted gas turbine unit coupled to an electrical generator, an industrial customer (e.g., electric energy produced at a wellbore operation using hydrocarbons extracted at the wellbore operation), a solar farm, a transportable solar array, a wind farm, and the like. The electric energy is sent from the power source 140 to the charging hub 130, where it is supplied to the mobile units 120 and stored in their respective electric energy storage device(s). The charging hub 130 is a centralized location, and may be transportable, that the mobile units 120 can visit for recharging their electric energy storage devices.

According to one or more embodiments of the present invention, the electric energy storage device can be a lithium-ion (solid state or liquid electrolyte) battery, a super charge ion battery (SCiB) using titanium niobium oxide as an anode, graphene sheets or balls as an anode, silicon saw dust and crushed glass nano-particles as green chemicals, zinc-air or lithium-air batteries as green technology, sodium-ion batteries, capacitors, super capacitors and the like, and suitable combinations thereof. The electric energy storage device may be capable of storing a particular capacity, such as 1000 kilowatt hours (kWh), 1500 kWh, 5000 kWh, etc., of electric energy per mobile unit 120. In an example in which the capacity of the electric energy storage device is 1000 kWh, it is estimated that the electric energy storage device will charge at the charging hub 130 in approximately 30 minutes, although charging times may vary based on different factors (type of electric energy storage device, temperature, type of power source, etc.). In the case of electric powered prime movers (or electric powered mobile units 120) described herein, the electric energy storage device of the mobile unit 120 can be used to power the mobile unit 120 (and/or a prime mover connected thereto). Consumption related to powering the mobile unit 120 can be, for example, at a rate of approximately 2 kWh per mile that the mobile unit 120 is transported.

The environment depicted in FIG. 1 enables electric energy to be transported to the sites 110 that may not have access to a power source (e.g., the power source 140), such as because the sites 110 are too remote from the power source 140, are disconnected from the power source 140 (such as in the case of an emergency or natural disaster), or do not have enough electric energy available at the site to supply the equipment located at the site. Traditional solutions to these type situations utilize reciprocating engines to convert fuel (e.g., gasoline, diesel, liquid natural gas, etc.) into shaft power to drive rotating machines at sites 110 (e.g., wellbore sites) or conversion into electric energy using a generator to drive rotating machines at well bore sites 110. However, engines and gas turbine powered generators are expensive to operate, produce noise and air pollution, are prone to breakdowns, and require maintenance. Using electric energy, supplied by the mobile units 120, reduce or eliminate many of the problems associated with traditional generators. For example, using electric power reduces or eliminates air and noise pollution at the site and is cheaper per kilowatt hour than electric energy produced by a traditional generator. Moreover, the electric energy storage devices require less maintenance and are not as prone to breakdowns as generators. The operation of diesel or fuel gas powered stationary engines or engines mounted on semi-trucks have safety issues due to high temperature engines operating near combustible hydrocarbons environment in terms of storage and production near the site 110. Further, these engines have to be hot fueled during the operating hydrocarbon production activity, thus increasing the chances of fire and explosion.

Costs can also be drastically reduced, for example in the case of a hydraulic fracturing operation, by replacing diesel fuel consuming reciprocating engines or prime movers with electric energy storage devices on mobile units 120. For a hydraulic fracturing operation that consumes 33.5 megawatts of electric energy, a typical hydraulic fracturing operation would consume 1864 gallons per hour of diesel fuel. Using electric energy storage units on mobile units 120 instead would consume the equivalent energy (diesel) of 784 gallons per hour. This significant savings in diesel fuel usage would result in significant cost reductions because electric energy is generally cheaper to acquire and safer to utilize than diesel fuel.

According to one or more embodiments of the present invention, the environment depicted in FIG. 1 can further include a power management system (PMS) 150 (also referred to as an “electric energy management system” (EEMS)) configured to communicate with one or more of the mobile units 120 and/or the charging hub 130 through wireless communication and cell towers or in other cases using satellite communication. The PMS 150 monitors electric energy levels via wireless communication, cellular or satellite communication of the electric energy storage devices of the mobile units 120. The PMS 150 can also monitor electric energy usage (e.g., a rate of usage) of equipment at the sites by monitoring the electric energy levels of the electric energy storage devices over time, also use predictive analytics and machine learning algorithms to predict energy consumption patterns of well-bore site 110 equipment. Accordingly, the PMS 150 can estimate how long an electric energy storage device can provide electric energy to the equipment at the site. This enables the PMS 150 to dispatch (either by sending an alert or autonomously) another mobile unit before the electric energy of the first mobile unit's electric energy is depleted.

In embodiments where the electric energy storage device is used to provide electric energy to the mobile unit 120 to enable the mobile unit 120 to operate, the PMS 150 can also monitor remaining electric energy of the electric energy storage device and cause the mobile unit 120 to leave the site 110 and return to the charging hub 130 with enough remaining electric energy to complete the trip between the site 110 and the charging hub 130. This predictive determination based on data analytics can be based on hourly factors such as cost and availability of electricity at nearby charging hubs, distance, traffic conditions, weather, speed limits, etc., between the site 110 and the charging hub 130.

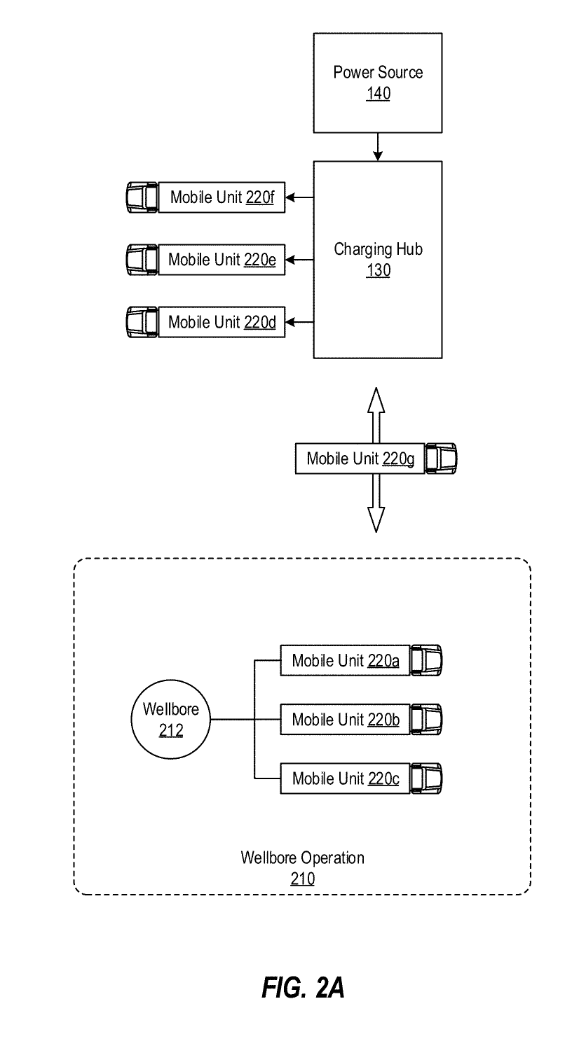

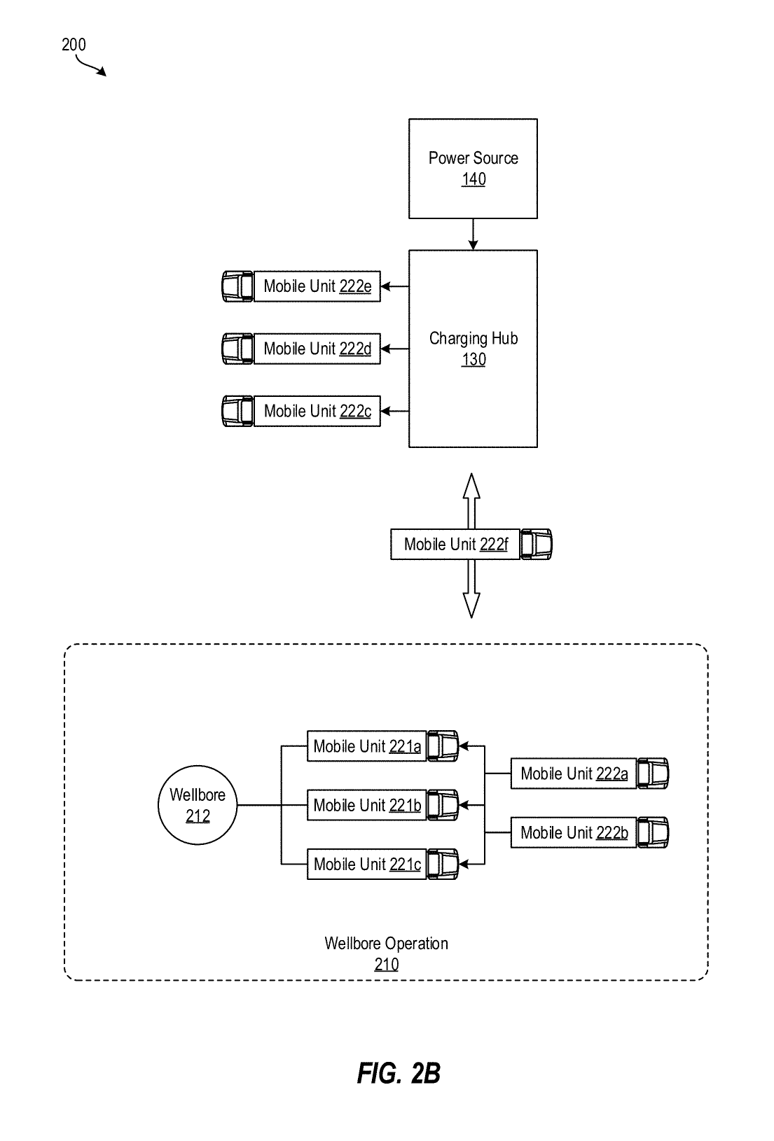

FIG. 2A depicts a wellbore operation 210 at which electric energy is supplied by a fleet of mobile units according to one or more embodiments of the present invention. The fleet of mobile units includes mobile unit 220a, 220b, 220c, 220d, 220e, 220f, 220g (collectively “mobile units 220”). The mobile units 220 are equipped with equipment (e.g., wire line units, cranes, sand loaders, pumps, blenders/mixers, etc.) to operate the wellbore operation 210 to extract hydrocarbons from the wellbore 212 and perform other well-bore operations such as coil tubing cleanout, logging, gas or water injection for enhanced recovery. The wellbore operation 210 can include a hydraulic fracturing operation. The mobile units 220 are also equipped with electric energy storage devices (each mobile unit 220 can include one or more such devices). The mobile units 220 receive electric energy at the charging hub 130, which receives the electric energy from a power source and provides it to the electric energy storage devices of the mobile units 220. As shown in FIG. 2A, some of the mobile units (e.g., the mobile units 220a, 220b, 220c) operate at the wellbore operation 210 while other mobile units (e.g., the mobile units 220d, 220e, 2200 charge at the charging hub. Some mobile units (e.g., the mobile unit 220g) are en route between the wellbore operation 210 and the charging hub 130 (e.g., to recharge and return to the wellbore operation 210).

FIG. 2B depicts a wellbore operation 210 at which electric energy is supplied by a fleet of mobile units according to one or more embodiments of the present invention. The fleet of mobile units includes mobile unit 222a, 222b, 222c, 222d, 222e, 222f (collectively “mobile units 222”). The mobile units 222 are equipped with electric energy storage devices (each mobile unit 222 can include one or more such devices). The mobile units 222 receive electric energy at the charging hub 130, which receives the electric energy from a power source and provides it to the electric energy storage devices of the mobile units 222.

The mobile units 222 supply electric energy to mobile units 221a, 221b, 221c (collectively, “mobile units 221”) which can be equipped with equipment (e.g., pumps, blenders/mixers, etc.) to operate the wellbore operation 210 to extract hydrocarbons from the wellbore 212. The mobile units 221 may or may not be equipped with their own electric energy storage devices. For example, an existing mobile unit (e.g., the mobile unit 221a) is configured to operate using diesel fuel powered engine at the wellbore operation 210 (such as from a diesel engine prime mover mounted on diesel semi-truck) can be retrofit to receive electric energy instead from one of the mobile units 222. In such an embodiment, the mobile units 221 remain at the wellbore operation 210 while the mobile units 222 move between the charging hub 130 and the wellbore operation 210 to recharge (at the charging hub 130) and deliver electric energy (at the wellbore operation 210). According to one or more embodiments of the present invention, one or more of the mobile units 222 can be configured as a mobile or field deployable solar array that can be used to receive solar energy at the wellbore operation 210 and convert the solar energy into electric energy that can be supplied to the mobile units 221 and/or the mobile units 222.

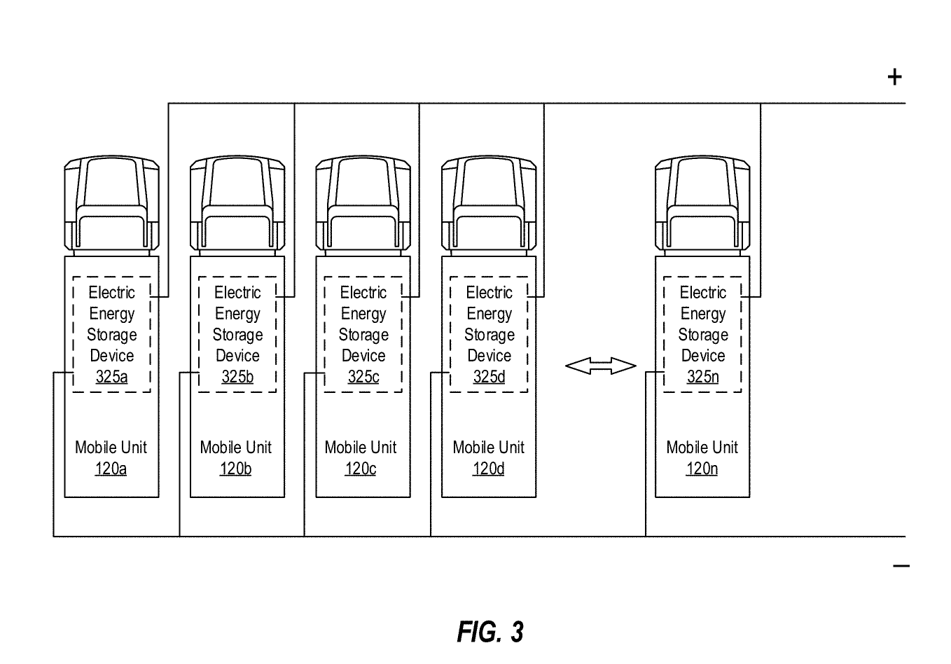

FIG. 3 depicts an arrangement of electric energy storage devices according to one or more embodiments of the present invention. At some sites, such as hydraulic fracturing operations, electric energy demands may exceed the capacity that is capable of being provided by a single electric energy storage device (or multiple electric energy storage devices on a single mobile unit 120). For example, typical hydraulic fracturing operations use approximately 35 megawatts (MW) of electric power. Each of the electric energy storage devices 325a, 325b, 325c, 325d, . . . 325n (collectively “electric energy storage devices 325”) may provide approximately 1 megawatt hour of electric energy. Accordingly, it may be desirable to arrange the electric energy storage devices 325 in parallel via a bus so that total electric energy supplied to wellbore 212 is increased in proportion to total number of electric energy storage devices 325. The parallel connected bus provides the same bus voltage but amps add proportionally to the number of electric energy storage devices so that electric energy is increased. Each of the electric energy storage devices 325a, 325b, 325c, 325d, . . . 325n is associated with a mobile unit (e.g., mobile units 120a, 120b, 120c, 120d, . . . 120n).

According to one or more embodiments of the present invention, by connecting the electric energy storage devices 325 in parallel (as depicted in FIG. 3), increased electric energy can be provided. If 35 mobile units 120, each containing an electric energy storage device 325 having a capacity of 1 MWh, are electrically connected in parallel, approximately 35 MWh of electric energy can be provided.

According to one or more embodiments of the present invention, by connecting the electric energy storage devices 325 in series (not depicted), a voltage boost can be provided. Moreover, in some embodiments, it may be desirable to use a combination of series and parallel connections among the electric energy storage devices 325 to match electric energy characteristics of particular equipment, such as hydraulic fracturing pumps, blenders/mixers, etc.

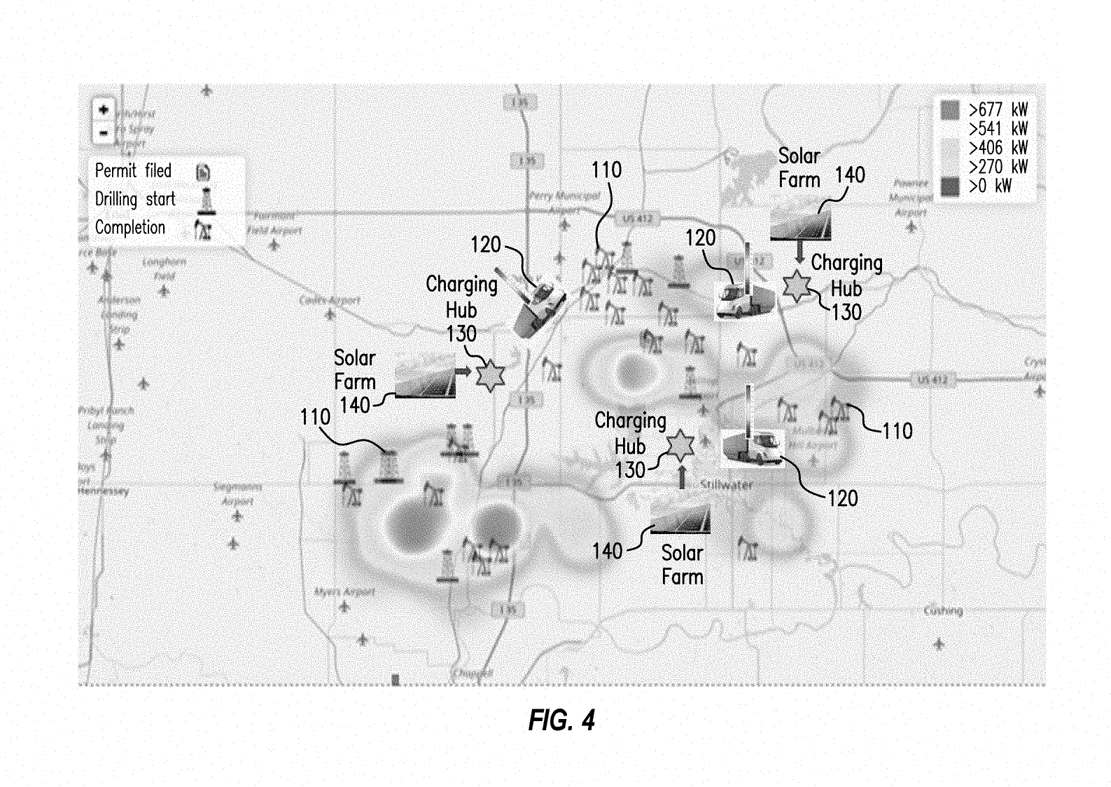

FIG. 4 depicts a power utilization heat map 400 indicating the local region average power utilization intensity based on type of oil field operations, such as drilling, completions, artificial lift, coil tube cleaning, etc. at a given time, relative position of mobile units 120, charging hubs 130, power sources 140, and sites 110 according to one or more embodiments of the present invention. The power heat map 400 can be, for example, a time based Geographical Information System (GIS) map, which can be used to gather, manage, and analyze instantaneous data, such as data relating to storing and providing electric energy to equipment at sites. In this example, the sites 110 are different types of wellbore operations, and the power sources 140 are solar farms. It should be appreciated that this example is merely illustrative, and other types of sites and/or power sources can be used including grid supplied power distribution lines. Another parameter that the GIS map can indicate is hourly/daily/monthly electricity rates ($/kWh) at charging hub 130.

As depicted in FIG. 4, each of the mobile units 120 is displayed with an associated charge meter to indicate an amount of electric energy stored therein. This can aid an observer of the map 400 with understanding which mobile units 120 to dispatch to which sites 110, for example, or to estimate when each mobile unit 120 may need to recharge at one of the charging hubs 130. The map 400 also includes a heat map that indicates “hot spots” of total power requirements. This may aid the distribution (or redistribution) of mobile units 120 among the sites 110.

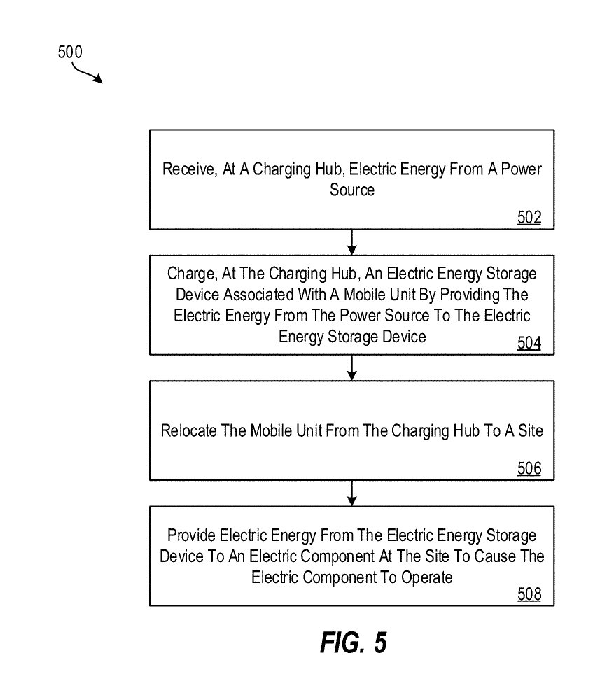

FIG. 5 depicts a method for providing storing and providing electric energy to equipment at the sites according to one or more embodiments of the present invention.

At block 502, electric energy is received at the charging hub 130 from the power source 140. The power source 140 can include different types of power sources, such as an electric utility, a solar farm, a wind farm, stationary or mobile gas turbine generator units and the like. In some examples, the electric energy is received from a hydrogen fuel cells, where hydrogen gas is generated using fuel gas from production wells or electrolysis of oilfield water.

At block 504, the electric energy storage device (e.g., the electric energy storage device 325) associated with the mobile unit 120 is charged. In particular, the charging hub 130 provides electric energy to the electric energy storage device from the power source. The electric energy storage device can include one or more rechargeable batteries.

At block 506, the mobile unit 120 is relocated from the charging hub 130 to a site 110. The relocation can occur, for example, once the electric energy storage device is charged. The relocation can be performed autonomously such that the mobile unit 120 is relocated without human intervention. In the case of autonomous relocation, the mobile unit 120 (and/or a prime mover associated therewith) is capable of sensing its environment and navigating that environment with limited human input or without human input.

At block 508, electric energy is provided from the electric energy storage device to an electric component at the site to cause the electric component to operate. For example, in the case of a hydraulic fracturing operation, the electric component can be an electric motor coupled to equipment such as a pump, a sand loader, a blender/mixer, etc. to provide electric energy to the electric motor to cause the equipment to operate.

Additional processes also may be included. According to one or more embodiments of the present invention, the method 500 further includes monitoring an electric energy level of the electric energy storage device of the mobile unit. The monitoring can be performed, for example, by the PMS 150. It can then be determined whether the electric energy level of the electric energy storage device meets a threshold level of electric energy. The threshold can be set based on factors such as distance, traffic conditions, weather, speed limits, etc., between the site 110 and the charging hub 130. That is, the threshold can be set so that sufficient electric energy remains in the electric energy storage device so that the mobile unit 120 can return to the charging hub 130 from the site 110. For example, a threshold may be higher for longer distances and lower for shorter distances.

When it is determined that the electric energy level of the electric energy storage device meets the threshold, the mobile unit 120 is relocated from the site 110 to the charging hub 130. The electric energy storage device associated with the mobile unit 120 is then recharged at the charging hub using electric energy from the power source. Once the electric energy storage device is recharged, the mobile unit 120 can be relocated back to the site 110 (or another site) from the charging hub 130. This process can repeat so that the mobile unit 120 periodically returns to the charging hub 130 to charge the electric energy storage device. In some examples, the charging/recharging can occur at particular times, such as during a non-production time of a wellbore operation, during off-peak electric energy hours (when prices for the electric energy provided by the power source may be lower), etc.

It should be understood that the process depicted in FIG. 5 represents an illustration, and that other processes may be added or existing processes may be removed, modified, or rearranged without departing from the scope and spirit of the present disclosure.

The teachings of the present disclosure may be used in a variety of well operations. These operations may involve operations such as well interventions, coil tubing, slickline or wireline, pulling tubulars or rods, using pumping one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

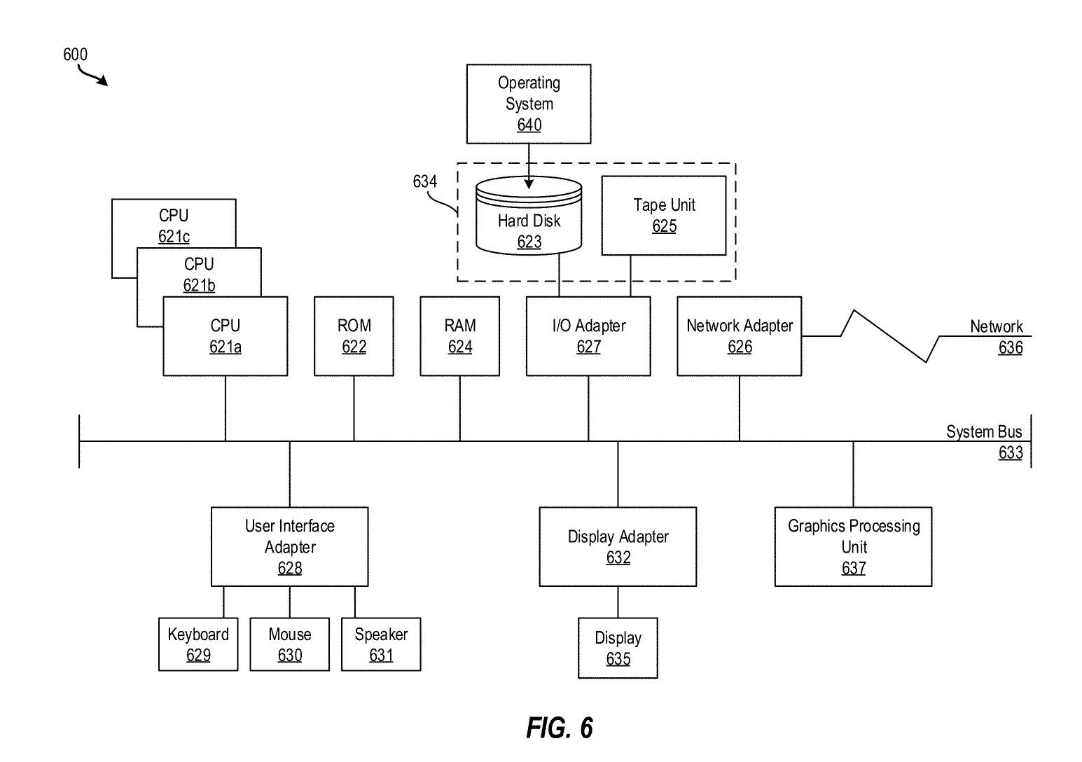

It is understood that the present disclosure is capable of being implemented in conjunction with any other type of computing environment now known or later developed. For example, FIG. 6 depicts a block diagram of a processing system 600 for implementing the techniques described herein. In examples, processing system 600 has one or more central processing units (processors) 621a, 621b, 621c, etc. (collectively or generically referred to as processor(s) 621 and/or as processing device(s)). In aspects of the present disclosure, each processor 621 can include a reduced instruction set computer (RISC) microprocessor. Processors 621 are coupled to system memory (e.g., random access memory (RAM) 624) and other components via a system bus 633. Read only memory (ROM) 622 is coupled to system bus 633 and may include a basic input/output system (BIOS), which controls certain basic functions of processing system 600.

Further depicted are an input/output (I/O) adapter 627 and a communications adapter 626 coupled to system bus 633. I/O adapter 627 may be a small computer system interface (SCSI) adapter that communicates with a hard disk 623 and/or a tape storage drive 625 or any other similar component. I/O adapter 627, hard disk 623, and tape storage device 625 are collectively referred to herein as mass storage 634. Operating system 640 for execution on processing system 600 may be stored in mass storage 634. A network adapter 626 interconnects system bus 633 with an outside network 636 enabling processing system 600 to communicate with other such systems.

A display (e.g., a display monitor) 635 is connected to system bus 633 by display adaptor 632, which may include a graphics adapter to improve the performance of graphics intensive applications and a video controller. In one aspect of the present disclosure, adapters 626, 627, and/or 232 may be connected to one or more I/O busses that are connected to system bus 633 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 633 via user interface adapter 628 and display adapter 632. A keyboard 629, mouse 630, and speaker 631 may be interconnected to system bus 633 via user interface adapter 628, which may include, for example, a Super I/O chip integrating multiple device adapters into a single integrated circuit.

In some aspects of the present disclosure, processing system 600 includes a graphics processing unit 637. Graphics processing unit 637 is a specialized electronic circuit designed to manipulate and alter memory to accelerate the creation of images in a frame buffer intended for output to a display. In general, graphics processing unit 637 is very efficient at manipulating computer graphics and image processing, and has a highly parallel structure that makes it more effective than general-purpose CPUs for algorithms where processing of large blocks of data is done in parallel.

Thus, as configured herein, processing system 600 includes processing capability in the form of processors 621, storage capability including system memory (e.g., RAM 624), and mass storage 634, input means such as keyboard 629 and mouse 630, and output capability including speaker 631 and display 635. In some aspects of the present disclosure, a portion of system memory (e.g., RAM 624) and mass storage 634 collectively store an operating system to coordinate the functions of the components shown in processing system 600.

According to one or more embodiments of the present invention, present techniques can be implemented on or using the processing system 600 found in FIG. 6. Additionally, a cloud computing system can be in wired or wireless electronic communication with one or all of the elements of the processing system 600. Cloud computing can supplement, support or replace some or all of the described herein. Additionally, some or all of the functionality of the elements (e.g., the PMS 150) of the present techniques can be implemented as a node of a cloud computing system. A cloud computing node is only one example of a suitable cloud computing node and is not intended to suggest any limitation as to the scope of use or functionality of embodiments described herein.

Set forth below are some embodiments of the foregoing disclosure:

### Embodiment 1

A method comprising: receiving, at a charging hub, electric energy from a power source; charging, at the charging hub, an electric energy storage device associated with an electric powered vehicle by providing the electric energy from the power source to the electric energy storage device; relocating the electric powered vehicle from the charging hub to a site; and providing electric energy from the electric energy storage device to the electric powered vehicle and an electric component at the site to cause the electric component to operate.

### Embodiment 2

A method according to any of the prior embodiments, wherein the power source is at least one of an electric utility, a gas turbine coupled to a generator, a solar farm, transportable solar array, and a wind farm.

### Embodiment 3

A method according to any of the prior embodiments, wherein the electric energy storage device comprises a plurality of rechargeable batteries.

### Embodiment 4

A method according to any of the prior embodiments, wherein the electric energy storage device comprises a battery, a capacitor, and a super capacitor.

### Embodiment 5

A method according to any of the prior embodiments, wherein the relocating is performed autonomously.

### Embodiment 6

A method according to any of the prior embodiments, further comprising: monitoring, by an electric energy management system, an electric energy level of the electric energy storage device of the electric powered vehicle; based at least on determining that the electric energy level of the electric energy storage device meets a threshold level of electric energy, relocating the electric powered vehicle from the site to the charging hub; charging, at the charging hub, the electric energy storage device associated with the electric powered vehicle by providing the electric energy from the power source to the electric energy storage device; and relocating the electric powered vehicle from the charging hub to the site.

### Embodiment 7

A method according to any of the prior embodiments, further comprising providing electric energy from the electric energy storage device to a prime mover associated with the electric powered vehicle.

### Embodiment 8

A method according to any of the prior embodiments, wherein the electric component is a wellbore component.

### Embodiment 9

A method according to any of the prior embodiments, wherein the site is a hydraulic fracturing operation.

### Embodiment 10

A mobile hydraulic fracturing unit comprising: a prime mover; at least one of a sand loader assembly, a pump assembly, and a blender assembly; an electric motor coupled to the at least one of the pump assembly and the blender assembly; and an electric energy storage device to provide electric energy to the prime mover and the electric motor coupled to the at least one of the pump assembly and the blender assembly.

### Embodiment 11

The mobile hydraulic fracturing unit of any of the prior embodiments, further comprising a control system to autonomously control the mobile hydraulic fracturing unit.

### Embodiment 12

The mobile hydraulic fracturing unit of any of the prior embodiments, further comprising an electric energy management and distribution system to monitor the electric energy storage device and energy consumption by the prime mover and the electric motor.

### Embodiment 13

A hydraulic fracturing operation comprising: a hydraulic fracturing unit comprising a hydraulic fracturing component and an electric motor coupled to the hydraulic fracturing component; and a mobile unit comprising an electric energy storage device to provide electric energy to the electric motor of the hydraulic fracturing unit.

### Embodiment 14

The hydraulic fracturing operation of any of the prior embodiments, wherein the hydraulic fracturing component comprises at least one of a pump assembly and a blender assembly.

### Embodiment 15

The hydraulic fracturing operation of any of the prior embodiments, wherein the mobile unit is configured to relocate between a charging hub and the hydraulic fracturing operation, wherein the charging hub is physically separated from the hydraulic fracturing operation.

### Embodiment 16

The hydraulic fracturing operation of any of the prior embodiments, wherein the electric energy storage device is configured to be recharged at a charging hub.

### Embodiment 17

The hydraulic fracturing operation of any of the prior embodiments, further comprising a mobile solar array configured to recharge the electric energy storage device of the mobile unit.

### Embodiment 18

The hydraulic fracturing operation of any of the prior embodiments, wherein an electrical connection is formed between the electric energy storage device of the mobile unit and another electric energy storage device, wherein the electrical connection is a series electrical connection.

### Embodiment 19

The hydraulic fracturing operation of any of the prior embodiments, wherein an electrical connection is formed between the electric energy storage device of the mobile unit and another electric energy storage device, wherein the electrical connection is a parallel electrical connection.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

While the invention has been described with reference to an exemplary embodiment or embodiments, it will be understood by those skilled in the art that changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A method comprising:
receiving, at a charging hub, electric energy from a power source;
charging, at the charging hub, an electric energy storage device associated with an electric powered vehicle by providing the electric energy from the power source to the electric energy storage device;
relocating the electric powered vehicle from the charging hub to a site; and
providing electric energy from the electric energy storage device to the electric powered vehicle and an electric component at the site to cause the electric component to operate.

2. The method of claim 1, wherein the power source is at least one of an electric utility, a gas turbine coupled to a generator, a solar farm, transportable solar array, and a wind farm.

3. The method of claim 1, wherein the electric energy storage device comprises a plurality of rechargeable batteries.

4. The method of claim 1, wherein the electric energy storage device comprises a battery, a capacitor, and a super capacitor.

5. The method of claim 1, wherein the relocating is performed autonomously.

6. The method of claim 1, further comprising:
monitoring, by an electric energy management system, an electric energy level of the electric energy storage device of the electric powered vehicle;
based at least on determining that the electric energy level of the electric energy storage device meets a threshold level of electric energy, relocating the electric powered vehicle from the site to the charging hub;
charging, at the charging hub, the electric energy storage device associated with the electric powered vehicle by providing the electric energy from the power source to the electric energy storage device; and
relocating the electric powered vehicle from the charging hub to the site.

7. The method of claim 1, further comprising providing electric energy from the electric energy storage device to a prime mover associated with the electric powered vehicle.

8. The method of claim 1, wherein the electric component is a wellbore component.

9. The method of claim 1, wherein the site is a hydraulic fracturing operation.

10. A mobile hydraulic fracturing unit comprising:
a prime mover;
at least one of a sand loader assembly, a pump assembly, and a blender assembly;
an electric motor coupled to the at least one of the pump assembly and the blender assembly; and
an electric energy storage device to provide electric energy to the prime mover and the electric motor coupled to the at least one of the pump assembly and the blender assembly.

11. The mobile hydraulic fracturing unit of claim 10, further comprising a control system to autonomously control the mobile hydraulic fracturing unit.

12. The mobile hydraulic fracturing unit of claim 10, further comprising an electric energy management and distribution system to monitor the electric energy storage device and energy consumption by the prime mover and the electric motor.

13. A hydraulic fracturing operation comprising:
a hydraulic fracturing unit comprising a hydraulic fracturing component and an electric motor coupled to the hydraulic fracturing component; and
a mobile unit comprising an electric energy storage device to provide electric energy to the electric motor of the hydraulic fracturing unit.

14. The hydraulic fracturing operation of claim 13, wherein the hydraulic fracturing component comprises at least one of a pump assembly and a blender assembly.

15. The hydraulic fracturing operation of claim 13, wherein the mobile unit is configured to relocate between a charging hub and the hydraulic fracturing operation, wherein the charging hub is physically separated from the hydraulic fracturing operation.

16. The hydraulic fracturing operation of claim 13, wherein the electric energy storage device is configured to be recharged at a charging hub.

17. The hydraulic fracturing operation of claim 13, further comprising a mobile solar array configured to recharge the electric energy storage device of the mobile unit.

18. The hydraulic fracturing operation of claim 13, wherein an electrical connection is formed between the electric energy storage device of the mobile unit and another electric energy storage device, wherein the electrical connection is a series electrical connection.

19. The hydraulic fracturing operation of claim 13, wherein an electrical connection is formed between the electric energy storage device of the mobile unit and another electric energy storage device, wherein the electrical connection is a parallel electrical connection.
